(19) United States
(12) Patent Application Publication
(10) Pub. No.: US 2024/0190038 A1
(43) Pub. Date: Jun. 13, 2024

(54) ASSEMBLY WITH OSB WITH ACOUSTIC DAMPENING PROPERTIES

(71) Applicant: LOUISIANA-PACIFIC CORPORATION, NASHVILLE, TN (US)

(72) Inventors: JIANWEN NI, FRANKLIN, TN (US); ASHWIN HIMATSINGANI, BRENTWOOD, TN (US)

(21) Appl. No.: 18/583,723

(22) Filed: Feb. 21, 2024

Related U.S. Application Data
(63) Continuation-in-part of application No. 17/517,130, filed on Nov. 2, 2021.
Application No. 17/517,130 is a continuation of application No. 15/832,327, filed on Dec. 5, 2017, now Pat. No. 11,161,272.
(60) Provisional application No. 63/447,752, filed on Feb. 23, 2023.
(60) Provisional application No. 62/429,986, filed on Dec. 5, 2016.

(51) Int. Cl. B27N 3/04; B27N 1/00; B27N 7/00; B32B 5/26; B32B 21/14; C08L 97/02; E04B 1/86; G10K 11/168

(52) U.S. Cl. CPC B27N 3/04; B27N 1/00; B27N 7/00; B32B 5/26; B32B 21/14; C08L 97/02; E04B 1/86; G10K 11/168; B32B 2255/08; B32B 2255/24; B32B 2262/067; B32B 2307/102; B32B 2607/00

(57) ABSTRACT

An assembly with acoustic dampening properties for use in building or structure construction, a first panel, a second panel, and one or more connection elements therebetween. The first panel is a manufactured-wood acoustic panel with multiple lignocellulosic material-based layers, wherein one or more of the layers having a noise-reducing polymer integrally coating or permeating the lignocellulosic material. The noise-reducing polymer does not form a homogenous layer. The assembly can include insulation, gypsum board, or similar materials to form wall assemblies, roof assemblies, floor assemblies, and ceiling assemblies.

This application claims priority to and benefit of U.S. Provisional Application No. 63/447,752, filed Feb. 21, 2023; this application also is a continuation-in-part application of in U.S. patent application Ser. No. 17/517,130, filed Nov. 2, 2021, which is a continuation of U.S. patent application Ser. No. 15/832,327, filed Dec. 5, 2017, which claims benefit of and priority to U.S. Provisional Application No. 62/429,896, filed Dec. 5, 2016; the specifications, figures, and complete disclosures of all of which are incorporated herein in their entireties by specific reference for all purposes.

### FIELD OF INVENTION

This invention relates to system and method for manufacturing and using wall, roof, floor, or other types of assemblies using wood products (such as OSB, oriented strand board) with acoustic dampening properties.

### BACKGROUND OF THE INVENTION

Acoustic comfort is important in building design. Noise is often the primary complaint by home-owners in residential single-family homes, and noise reduction also is an important performance criterion in multi-family and commercial construction (particularly in the healthcare and education segments). Airborne noise/STC (Sound Transmission Class) rating (which is the difference in decibels through a product, i.e., how much sound is getting through) and impact noise (Impact Insulation Class, IIC) rating in wall and floor or ceiling assemblies often is specified in codes and standards by IBC, ANSI, IgCC, ASTM, and the like.

Airborne noise from outside or inside the living space has been addressed with various field-applied and pre-fabricated noise dampening constructions products, such as resilient channels, clips, staggered studs, multiple layers of drywall, wall cavity insulation, and laminated acoustic drywall. Acoustic materials have been used to laminate two panels of various building materials through a secondary process to improve acoustic performance. However, there are no building materials, such as OSB-based siding, sheathing, roofing or flooring, that incorporate a sound dampening material in the primary manufacturing process of panels with improved acoustic performance.

### BRIEF DESCRIPTION OF THE DRAWINGS

FIG. 1 shows a view of a system in accordance with an embodiment of the present invention.

FIG. 2 shows another system in accordance with another embodiment of the present invention.

FIG. 3 shows another system in accordance with another embodiment of the present invention.

FIG. 4 shows a basic acoustic assembly comprising one or more panels with acoustic dampening properties.

FIG. 5 shows a multi-family floor and/or ceiling acoustic assembly with gypsum board.

FIG. 6 shows a multi-family floor and/or ceiling acoustic assembly with gypsum board and resilient channel.

FIG. 7 shows a multi-family floor and/or ceiling acoustic assembly with double gypsum boards and resilient channel.

FIG. 8 shows a multi-family floor and/or ceiling acoustic assembly with double gypsum boards.

FIG. 9 shows a single-family exterior wall acoustic assembly with housewrap and vinyl siding.

FIG. 10 shows a single-family exterior wall acoustic assembly with housewrap and fiber-cement siding.

FIG. 11 shows a single-family ceiling and/or roof or vent acoustic assembly.

### DETAILED DESCRIPTION OF EXEMPLARY EMBODIMENTS

In various exemplary embodiments, the present invention comprises a method or process for manufacturing wood products with acoustic dampening properties. The manufactured wood products include, but are not limited to, oriented strand board (OSB), LSL, MDF, particleboard, or various wood composites.

In several embodiments, the present invention comprises a system for introducing a noise-dampening polymer in-line in the manufacturing process to achieve higher acoustic performance (e.g., STC and/or IIC rating) in siding, sheathing, roofing, flooring, and similar applications using the manufactured wood product. The polymer can be a viscoelastic polymer which is added during blending or formation of the wood product. In one exemplary embodiment, as described in greater detail below, viscoelastic polymer is added to the center strand layer during the OSB manufacturing process.

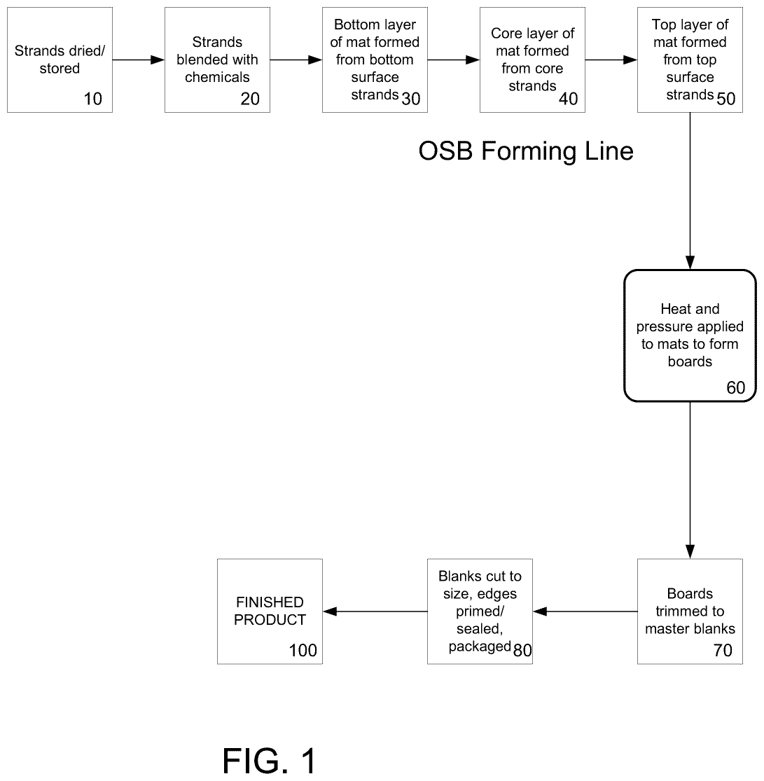

General elements of the OSB manufacturing process in accordance with the present invention, as seen in FIG. 1, include the drying and storing of wood strands 10, the treatment or blending of designated strands (e.g., bottom, core, top) with applicable chemicals and/or additives (e.g., wax, resin, and the like) 20, the forming of the appropriate layers in order (first bottom surface, then core, then top surface) using designated strands, 30, 40, 50, the application of heat and pressure to the mats using a primary press to form boards 60, and subsequent trimming 70 and processing (e.g., panels cut to size, edges primed/sealed, and packaging) 80 to produce the finished product 100. Strands for a particular layer typically are blended with applicable chemicals and/or additives in a blender or bin, separate from strands for other layers, although this is not always the case. Examples of primary processes are described in U.S. Pat. Nos. 6,461,743; 5,718,786; 5,525,394; 5,470,631; and 5,425,976; all of which are incorporated herein in their entireties by specific reference for all purposes.

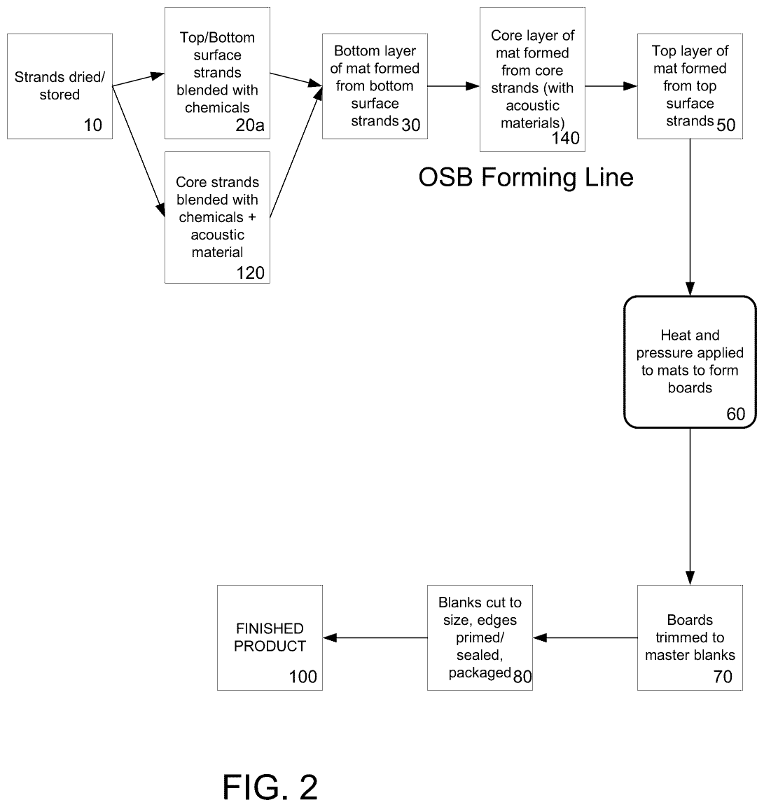

FIG. 2 shows an embodiment of the manufacturing process where the core strands are coated with the noise-dampening polymer in a strand blender or blenders 120. The top and bottom surface strands are blended separately 20a, although in some embodiments, one or both sets of strands also may be blended with a noise-dampening polymer. The polymer can be blended with the core strands separately, or along with other additives typically added during the OSB process, such as waxes or resin binders. The treated core strands are used to form the central core layer 140, sandwiched between the bottom surface and top surface. The finished product is an OSB panel (or other manufactured wood product) with a core layer with core strands blended with the noise-dampening acoustic material or materials. The heat and pressure applied during the primary pressing process promotes the noise-dampening acoustic material to integrally coat, permeate or infuse the core layer, and in several embodiments, portions of the bottom and/or top surface layers.

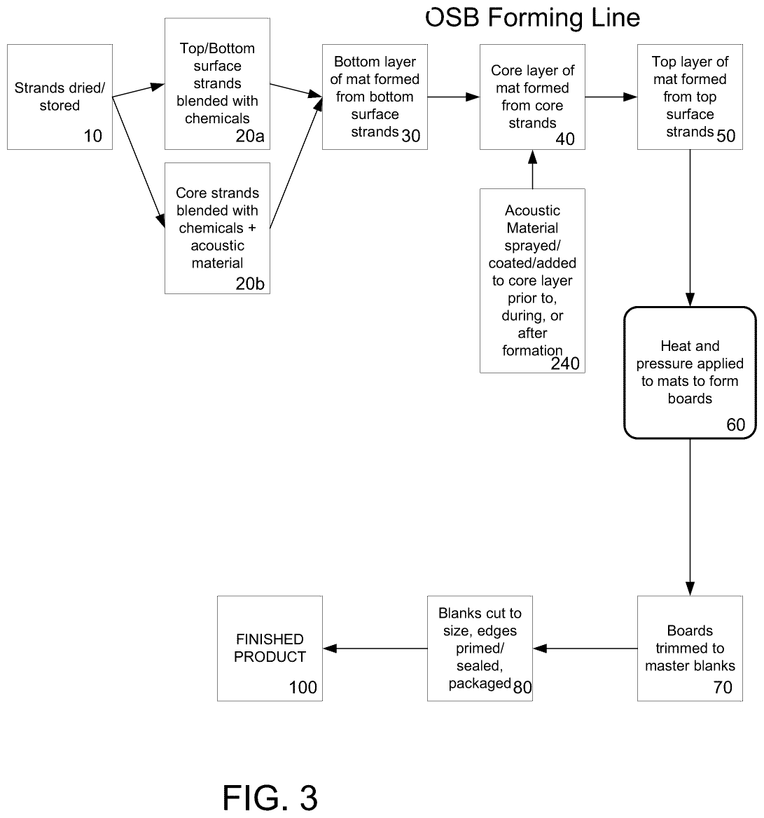

FIG. 3 shows another second embodiment of the manufacturing process where, after blending of the strands 20a, b, the noise-dampening acoustic material or materials are applied through a spraying, flow, curtain or other coating process 240 in the forming line before, during, or after the center core strand layer is laid on the forming line. The finished product is an OSB panel (or other manufactured wood product) with a central layer with core strands coated with the noise-dampening acoustic material or materials. As described above, the heat and pressure applied during the primary pressing process promotes the noise-dampening acoustic material to integrally coat, permeate or infuse the core layer, and in several embodiments, portions of the bottom and/or top surface layers.

The components and parameters of the above processes can vary. In one exemplary embodiment, the wood strands can be derived from hardwood (e.g., aspen) or softwood (e.g., southern yellow pine), and can be homogenous (i.e., single wood type) or mixed, and green (moisture content from about 30% to about 200%) or dried (e.g., moisture content up to about 12%) (where moisture content %=(weight of water in wood/oven-dry weight of wood)×100). Binders include, but are not limited to, isocyanate resin, urea-formaldehyde, phenol formaldehyde, melamine formaldehyde, bio-adhesives, or combinations thereof. In one embodiment, polymeric isocyanate resin (pMDI, or polymeric diphenylmethane diisocyanate) is used at about 1.2 weight % to about 20 weight %. Waxes include, but are not limited to, a molten wax or was emulsion (in one embodiment, up to about 2.5 weight %). Other chemicals or additives may be used, including, for example, fire retardants, water repellents, fungicides, insecticides, or the like. Viscoelastic polymer is added as described above to the center layer or any other layer in the mat. Press time is from 1 to 20 minutes at a temperature from about 100° C. to about 240° C. The resulting panel can range in thickness from about ¼″ to about 7″, and in density from about 25 pcf to about 60 pcf (pounds per cubic foot).

In any of the above embodiments, the thickness and/or density of the top or bottom strand layer, or both, can be modified as well to achieve an improved acoustic performance/STC rating. The present invention thus provides an OSB or manufactured wood panel with a noise-dampening polymer introduced in-line, with a resulting increase (1) in acoustic performance as compared to a standard OSB panel, and (2) in efficiency and reduction in cost compared to secondary manufacturing processes. The noise-dampening polymer becomes integrated with, and infuses or permeates the layer or layers of the panel.

In several embodiments, the noise-dampening of the present invention applies to both airborne sound transmission loss and impact sound insulation. In some embodiments, panels produced in accordance with the present invention smooth airborne sound transmission loss curves in the ASTM E90 test method, particularly increasing loss (dB) in frequency ranges where sound is transmitted more effectively due to physical characteristics (i.e., of a similar panel but without the sound-dampening agent). In one embodiment, the present invention increases airborne transmission loss in the sound frequency ranges of from about 1.5K to about 4K Hz (more particularly, from about 2K to about 3.2K Hz, or even more particularly, from about 2.5K to about 3.15K Hz).

In additional embodiments, panels produced in accordance with the present invention demonstrate increased impact sound insulation and decreased sound pressure levels. In one embodiment, such panels have a tested apparent impact insulation class (AIIC) rating in the range from about 26 to about 34, as determined by ASTM Standard E-1007 (2016). In contrast, a control panel without noise-dampening polymer had an AIIC rating of 19.

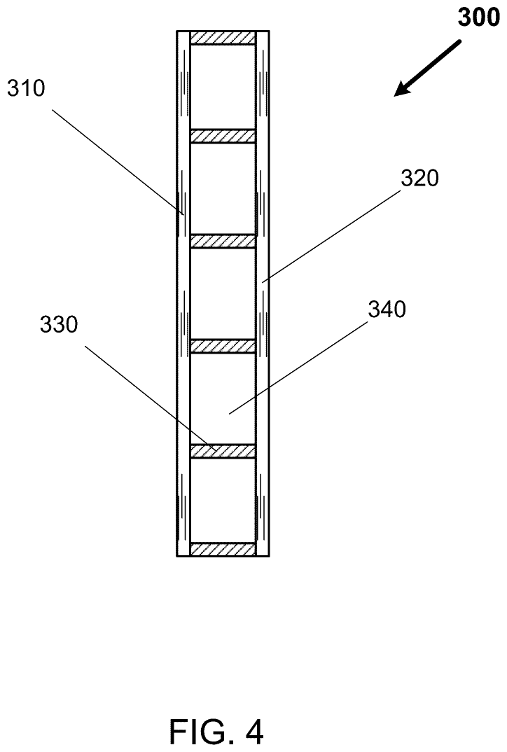

Panels produced in accordance with the present invention can be incorporated into various forms of assemblies, including wall, roof, ceiling floor, and other types of assemblies. FIG. 4 shows a basic assembly 300 configuration, comprising an interior panel 310, an exterior panel 320, and one or more connection elements 330 therebetween, such as, but not limited to, studs, joists and/or framing. In several embodiments, there is space 340 between the connection elements and the panels, which may contain or be filled, in whole or in part, with a variety of materials, such as various forms of insulation.

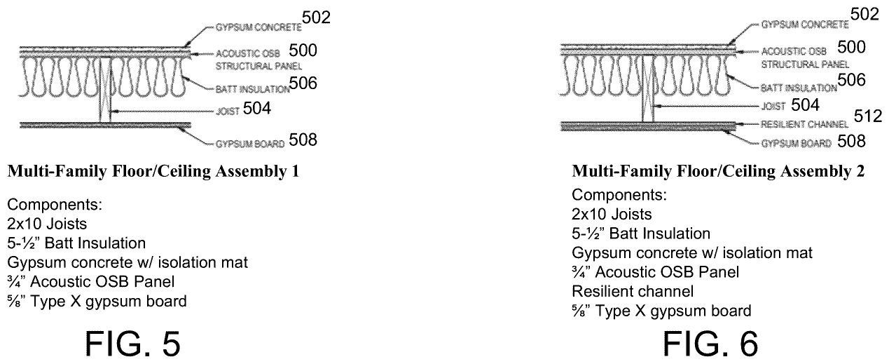

FIGS. 5-11 illustrate several exemplary assemblies where acoustic panels as described above may be used to significantly improve STC ratings for the assembly. A number of the figures show acoustic OSB panels (as described above) being used as the exterior (or structural) panel in the assembly. However, it should be noted that acoustic panels may also be used as interior panels, or as both interior and exterior panels in the same assembly.

FIG. 5 shows a multi-family floor and/or ceiling acoustic assembly comprising a layer of gypsum concrete with isolation mat 502, a ¾″ acoustic OSB panel 500, 5½″ batt insulation 506, 2″×10″ joists 504, and ⅝″ Type X gypsum board 508. With the acoustic OSB panel 500, the STC (Sound Transmission Class) rating for this assembly is raised to 50 or above.

FIG. 6 shows another embodiment of a multi-family floor and/or ceiling acoustic assembly comprising a layer of gypsum concrete with isolation mat 502, a ¾″ acoustic OSB panel 500, 5½″ batt insulation 506, 2″×10″ joists, a resilient channel 512, and ⅝″ Type X gypsum board 508. With the acoustic OSB panel 500, the STC rating for this assembly is raised to 60 or above.

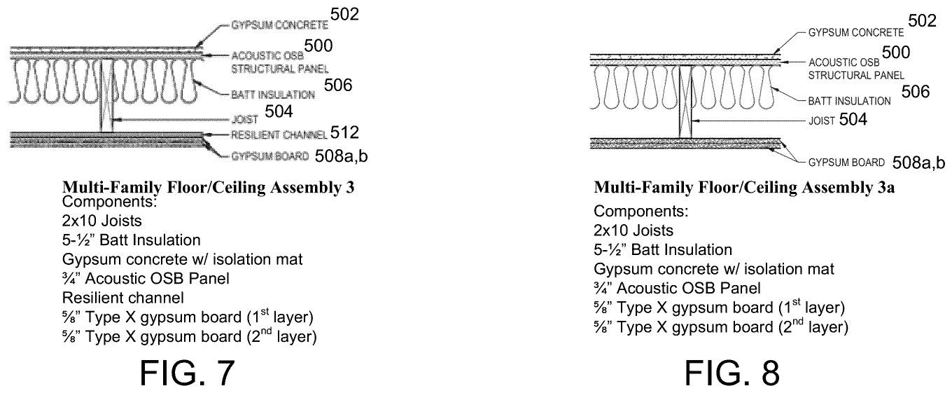

FIG. 7 shows a multi-family floor and/or ceiling acoustic assembly comprising a layer of gypsum concrete with isolation mat 502, a ¾″ acoustic OSB panel 500, 5½″ batt insulation 506, 2″×10″ joists 504, a resilient channel 512, and two ⅝″ Type X gypsum boards 508a,b. With the acoustic OSB panel 500, the STC rating for this assembly is raised to 65 or above.

FIG. 8 shows another embodiment of a multi-family floor and/or ceiling acoustic assembly comprising a layer of gypsum concrete with isolation mat 502, a ¾″ acoustic OSB panel 500, 5½″ batt insulation 506, 2″×4″ joists 504, and two ⅝″ Type X gypsum boards 508a,b. With the acoustic OSB panel 500, the STC rating for this assembly is raised to 60 or above.

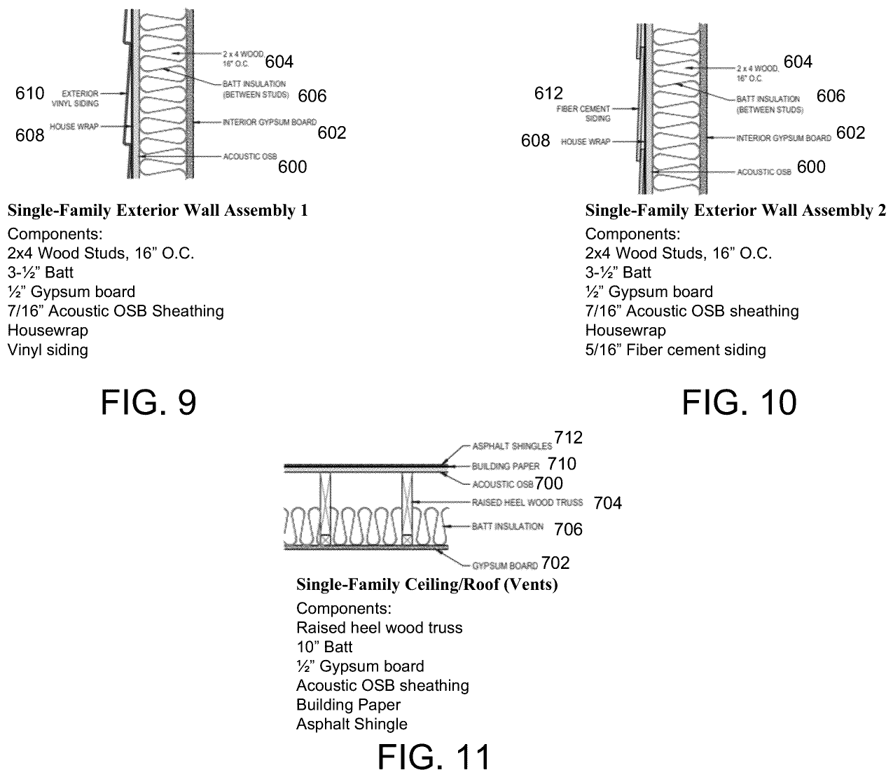

FIG. 9 shows a single-family exterior wall acoustic assembly comprising a ½″ interior gypsum board 602, 3½″ batt insulation (between wall studs) 606, 2″×4″ wood studs, 16″ on center (O.C.) 604, a 7/16″ acoustic OSB sheathing panel 600, a house wrap 608, and exterior vinyl siding 610. With the acoustic OSB panel 600, the STC rating for this assembly is raised to 40 or above.

FIG. 10 shows another embodiment of a single-family exterior wall acoustic assembly comprising a ½″ interior gypsum board 602, 3½″ batt insulation (between wall studs) 606, 2″×4″ wood studs, 16″ on center (O.C.) 604, a 7/16″ acoustic OSB sheathing panel 600, a house wrap 608, and exterior 5/16″ fiber cement siding 612. With the acoustic OSB panel 600, the STC rating for this assembly is raised to 45 or above.

FIG. 11 shows another embodiment of a single-family ceiling and/or roof acoustic assembly comprising a ½″ interior gypsum board 702, 10″ batt insulation (between truss beams) 706, raised heel wood truss beams 704, a 7/16″ acoustic OSB sheathing panel 700, building paper 710, and exterior asphalt shingles 712. With the acoustic OSB panel 600, the STC rating for this assembly is raised to 55 or above.

Accordingly, disclosed herein is an apparatus with acoustic dampening properties for use in building or structure construction, comprising:
an assembly comprising a first panel, a second panel, and one or more connection elements therebetween;
wherein the first panel comprises an acoustic panel with multiple lignocellulosic material-based layers, wherein one or more of said multiple lignocellulosic material-based layers comprise a noise-reducing polymer integrally coating or permeating the lignocellulosic material forming said one or more layers through application of heat and pressure during formation of the acoustic panel, further wherein the noise-reducing polymer does not form a homogenous layer.

The multiple layers may comprise a bottom layer, a core layer, and a top layer. One or more layers may comprise lignocellulosic strands. The acoustic panel may be an oriented-strand board (OSB) acoustic panel.

The noise-reducing polymer is integrated with the material forming the core layer. The noise-reducing polymer may be a viscoelastic polymer.

The assembly may comprise an interior wall assembly, an exterior wall assembly, a ceiling assembly, a floor assembly, or a roof assembly. The assembly may comprise insulation disposed between the first panel and the second panel. The one or more connection elements may comprise one or more joists or studs or truss. The second panel also may be an acoustic panel. In an embodiment, the first panel is an oriented-strand board (OSB) acoustic panel, and the second panel comprises a gypsum board or gypsum concrete. The second panel may, in some embodiments, be a double-layer panel (e.g., double layered gypsum board). A layer of gypsum concrete may be disposed on a surface of the first panel. Alternatively, a layer of building paper may be disposed on a surface of the first panel, and a layer of shingles disposed on a side of the layer of building paper opposite the first panel. The layer of shingles may comprise wood or asphalt shingles.

In one embodiment, the assembly has a Sound Transmission Class rating of at least 40. In another embodiment, the assembly has a Sound Transmission Class rating of at least 45. In another embodiment, the assembly has a Sound Transmission Class rating of at least 50. In another embodiment, the assembly has a Sound Transmission Class rating of at least 55. In another embodiment, the assembly has a Sound Transmission Class rating of at least 60. In another embodiment, the assembly has a Sound Transmission Class rating of at least 65.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. An apparatus with acoustic dampening properties for use in building or structure construction, comprising:
an assembly comprising a first panel, a second panel, and one or more connection elements therebetween;
wherein the first panel comprises an acoustic panel with multiple lignocellulosic material-based layers, wherein one or more of said multiple lignocellulosic material-based layers comprise a noise-reducing polymer integrally coating or permeating the lignocellulosic material forming said one or more layers through application of heat and pressure during formation of the acoustic panel, further wherein the noise-reducing polymer does not form a homogenous layer.

2. The apparatus of claim 1, wherein the multiple layers comprise a bottom layer, a core layer, and a top layer.

3. The apparatus of claim 1, wherein the noise-reducing polymer is integrated with the material forming the core layer.

4. The apparatus of claim 1, wherein said one or more layers comprise lignocellulosic strands.

5. The apparatus of claim 1, wherein the acoustic panel is an oriented-strand board (OSB) acoustic panel.

6. The apparatus of claim 1, wherein the noise-reducing polymer is a viscoelastic polymer.

7. The apparatus of claim 1, wherein the assembly comprises an interior wall assembly, an exterior wall assembly, a ceiling assembly, a floor assembly, or a roof assembly.

8. The apparatus of claim 1, the assembly further comprising insulation disposed between the first panel and the second panel.

9. The apparatus of claim 1, wherein the one or more connection elements comprise one or more joists or studs or truss.

10. The apparatus of claim 1, wherein the second panel also comprises an acoustic panel.

11. The apparatus of claim 1, wherein the first panel is an oriented-strand board (OSB) acoustic panel, and the second panel comprises a gypsum board or gypsum concrete.

12. The apparatus of claim 11, wherein the second panel is a double-layer panel.

13. The apparatus of claim 11, further comprising a layer of gypsum concrete disposed on a surface of the first panel.

14. The apparatus of claim 11, further comprising a layer of building paper disposed on a surface of the first panel, and a layer of shingles disposed on a side of the layer of building paper opposite the first panel.

15. The apparatus of claim 14, wherein the layer of shingles comprises wood or asphalt shingles.

16. The apparatus of claim 1, wherein the assembly has a Sound Transmission Class rating of at least 40.

17. The apparatus of claim 1, wherein the assembly has a Sound Transmission Class rating of at least 50.

18. The apparatus of claim 1, wherein the assembly has a Sound Transmission Class rating of at least 60.

19. The apparatus of claim 1, wherein the assembly has a Sound Transmission Class rating of at least 65.
